(19) United States
(12) Patent Application Publication
(10) Pub. No.: US 2006/0088634 A1
(43) Pub. Date: Apr. 27, 2006

(54) Process for granulation of low-moisture processed foods and use thereof

(75) Inventors: Manoj Shah, Lindenhurst, IL (US); Nicole Remily, Richland, MI (US); Kenchu A. Tham, Sparta, NJ (US); Allan R. Olson, Kalamazoo, MI (US); Phillip F. Litsas, Battle Creek, MI (US)

Correspondence Address: FITCH EVEN TABIN & FLANNERY, 120 S. LASALLE STREET, SUITE 1600, CHICAGO, IL, 60603-3406, US

(73) Assignee: Kraft Foods Holdings, Inc., Northfield, IL (US)

(21) Appl. No.: 10/972,089

(22) Filed: Oct. 25, 2004

(51) Int. Cl. A23P 1/00

(52) U.S. Cl. 426/518

(57) ABSTRACT

A process for grinding low-moisture processed food in a single unit operation in a continuous, short-duration manner. Grinding may be effected without the need for moving mechanical parts. The granulated food product obtained from the grinding treatment of low-moisture processed food is functionally suitable for re-use in food production lines.

### FIELD OF THE INVENTION

The invention generally relates to a process for grinding low-moisture processed foods and incorporation of the ground products thereof in food products.

### BACKGROUND OF THE INVENTION

In the production of many types of food products, some unused processed food portions are sometimes left as trimmings, shreds, offcuts, fragments, and so forth, after a batch run or other production run. Also, small quantities of processed food product that may not conform to a desired shape or configuration also may be rejected and not used in a commercial product. Ideally, such small quantities are combined with larger quantities for use as rework in subsequent food production. This often requires heating, mechanical grinding, milling or other processing steps to reform the processed food into a more convenient or stable form, which can lead to difficulties.

Farinaceous (starch-containing) foods can be subject to gelatinization or other significant physico-chemical transformations upon heat treatment or exposure to heat associated with conventional grinding or milling operations. For commercial reasons, control of gelatinization of farinaceous material in some food systems is important as it may have a direct impact on final product quality, particularly product texture. In addition, the degree of gelatinization of farinaceous material in food systems also impacts the processing rheology of a starch melt/dough or similar foodstuff. This may affect the expansion and bubble growth kinetics of the food product. A farinaceous food material may not be economically and/or functionally useful in further processed food production if the original starch content becomes unduly degraded.

Arrangements are needed for reforming low moisture processed foods at a high recovery rate in a shelf-stable, food grade, functional form for re-use, and entails fewer process steps and equipment requirements. The invention addresses the above and other needs in an efficient and economically feasible manner.

### SUMMARY OF THE INVENTION

This invention provides a process for grinding low-moisture processed foods into re-usable food grade, functional particulate forms. This process performs the treatment in a short-duration operation that substantially preserves desirable functional aspects of the processed foods which are useful for food manufacture. Grinding may be effected without the need to contact the low-moisture processed food with any moving mechanical parts. In certain embodiments, essentially all the low-moisture processed food material reformed in this manner may be incorporated into food products.

In one aspect, a food product is obtained from this process incurs sufficiently limited molecular structural degradation during this process such that the product of this process is functionally and organoleptically acceptable to be used as rework. In one particular aspect, the structural degradation of starch content of a processed food is avoided or minimized by this process. For purposes herein, a “processed food” refers to a food material which has already undergone a physical or chemical change as part of a previous food treatment, such as a thermal treatment, causing the character thereof to be different from the original food material. Such processed foods tend to be more sensitive to further treatment, and thus generally may be less apt to tolerate it without undergoing significant structural degradation.

In some embodiments, the types of low-moisture processed foods that may be reformed may be low-moisture processed foods which contain a grain-based ingredient, for example, from low-moisture doughs. Such low-moisture doughs may include, for example, bread doughs, pizza doughs, cereal doughs, pet food doughs, cracker doughs, baked good doughs, and the like.

In one particular embodiment, the grain-based ingredient comprises farinaceous material, and granular food products containing a farinaceous material emerge from the grinding treatment substantially functionally intact and substantially without loss of flavor. In this embodiment, the grinding treatment effectively granulates low-moisture processed foods containing farinaceous material without inducing significant or uncontrolled starch gelatinization. That is, sufficient original starch structure in particular in these processed foods is retained intact and preserved through the treatment to yield a food product having functional and organoleptic attributes acceptable for reuse in rework.

In some embodiments, the reclamation of low-moisture processed food is conducted as a grinding process in which compressed air and low-moisture processed food are separately introduced into an enclosure that includes a truncated conical shaped section. After introduction, the compressed air travels generally along a downward path through the enclosure until it reaches a lower end thereof. The air flows back up from the lower end of the enclosure in a central region thereof until exiting the enclosure via an exhaust duct. The low-moisture processed food is separately introduced into an upper end of the enclosure, and the food becomes entrained in the air traveling downward through the enclosure until reaching the lower end of the enclosure. In one embodiment, the compressed air is introduced into the enclosure in heated state, although this is not necessarily required as the feed material has a low moisture content.

During this movement of the processed food from the upper end of the enclosure down to the lower end thereof, the processed food is at least physically processed. The food also may be further dehydrated by use of heated compressed air in which it is suspended in a dynamic air flow system. During the same unit operation, the food is disintegrated into small particles in an extremely short duration of time. After introducing the processed food into the process unit, the processed food is processed and discharged from the process unit in a short duration of time, which can be less than about 60 seconds, particularly less than about 30 seconds, and more particularly less than about 10 seconds. Significant amounts of the introduced low-moisture processed food can be ground before reaching a lower end of the enclosure. As such, this attrition of the low-moisture processed food into granular form may be achieved without a grinding device using moving mechanical parts.

Consequently, in these embodiments, a solid particulate product including ground food is discharged and recovered from the lower end of the enclosure, while air and any moisture vapor released from the food during processing within the unit is exhausted from the system via the exhaust duct. In one particular embodiment, the enclosure is a two-part structure including an upper cylindrical shaped enclosure in which the compressed air and low-moisture processed food are separately introduced, and the cylindrical enclosure adjoins and fluidly communicates with a lower enclosure having the truncated conical shape that includes the lower end of the overall structure from which the processed feed material is dispensed.

Grinding low-moisture processed foods in accordance with embodiments of this invention offers numerous advantages over conventional schemes for disposal of low-moisture processed food. For one, costs associated with transporting and disposing of a food material are reduced or eliminated. The grinding treatment makes it possible to produce a granular food product from low-moisture processed food at a relatively low temperature, short duration procedure. The grinding treatment preferably may be achieved as a single-stage operation without impairing the desirable functional attributes of the food material, and without requiring different processes be performed in different equipment. Additionally, the process can be operated in a continuous mode as the compressed air is continuously exhausted from the system after entraining the food downward through the enclosure to its lower end, and ground food product material can be withdrawn from the lower end of the enclosure. Relatively little if any food residue is left on the inner walls of the processing unit, making it easy to clean and facilitating switching to a different type of processed food for processing within the unit. These advantages reduce process complexity, production time, and production and service costs.

### BRIEF DESCRIPTION OF THE DRAWINGS

Other features and advantages of the invention will become apparent from the following detailed description of preferred embodiments of the invention with reference to the drawings, in which:

FIG. 1 is a flow chart of a method for processing and re-using low-moisture processed food according to an embodiment of this invention.

FIG. 2 is a schematic view of a system useful for processing low-moisture processed food according to an embodiment of this invention.

FIG. 3 is a cross sectional view of the cyclone unit used in the processing system illustrated in FIG. 2.

FIG. 4 is a schematic view of a system useful for processing processed food according to another embodiment of this invention.

FIG. 5 is a microphotograph (300×) of a sample of dried and granulated soda cracker dough product obtained via processing of soda crackers according to an embodiment of this invention.

FIG. 6 is a microphotograph (300×), as viewed with polarized light, of a sample of dried and granulated soda cracker dough product obtained via processing of soda crackers according to an embodiment of this invention.

The features depicted in the figures are not necessarily drawn to scale. Similarly numbered elements in different figures represent similar components unless indicated otherwise.

### DETAILED DESCRIPTION OF THE PREFERRED EMBODIMENTS

Preferred embodiments of the invention will be described below with specific reference to unique processing of low-moisture processed foods. For purposes herein, the term “low-moisture” as used to characterize a food material means food material containing less than about 14 wt. % total water content, in liquid, frozen and/or vapor form.

Generally, low-moisture processed food is ground into a small particle size within a short period of time in a grinding process performed in one unit operation. In general, the grinding process is implemented on a cyclonic type system that may be operated in a manner whereby the low-moisture processed food may be physically acted upon in a beneficial manner. A ground food product is obtained in a granulated form (e.g., a solid fine particulate).

For purposes herein, “grinding” a particle means crushing, pulverizing, abrading, wearing, or rubbing the particle to break it down into smaller particles and/or liberate smaller particles, and includes mechanisms involving contact between moving particles, and/or between a moving particle and a static surface; and “drying” means dehydrating, i.e., a reducing moisture content.

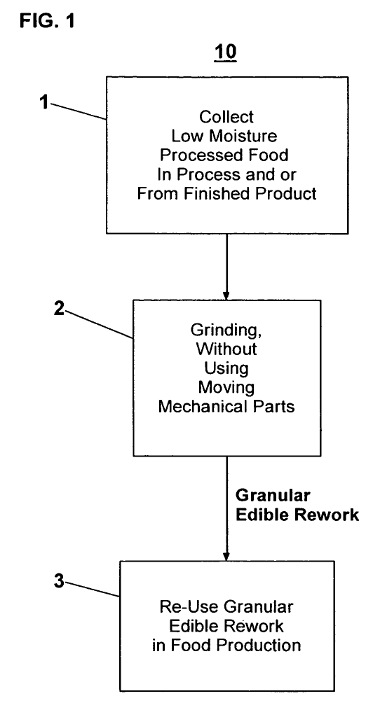

Referring to FIG. 1, in this non-limiting illustrated embodiment low-moisture processed food is collected in process or from finished food product (step 1), then is subjected to a grinding treatment (step 2), and the resulting granular food product thereof or “rework” is made available for re-use as a food ingredient (step 3).

In step 2, a granular food product is obtained which is suitable for use in comestibles. For instance, the granulated food product obtained substantially retains its flavor and functional attributes through the grinding treatment. For instance, when the low-moisture food is a farinaceous material, residual starch content of the low-moisture foods that remains after any prior cooking or other thermal treatments are performed on the processed food is substantially maintained through the grinding process according to the present invention, and thus is functionally available for re-use.

The granular food product also may be stably stored until re-used in subsequent food production. The granulated food product may be used as a food ingredient in the same type of processed food production line from which it was collected as an unused product, or in a different type of processed food production line in which its flavor or functional attributes may be desirable or useful. It also may be re-used at relatively high levels in further food production lines.

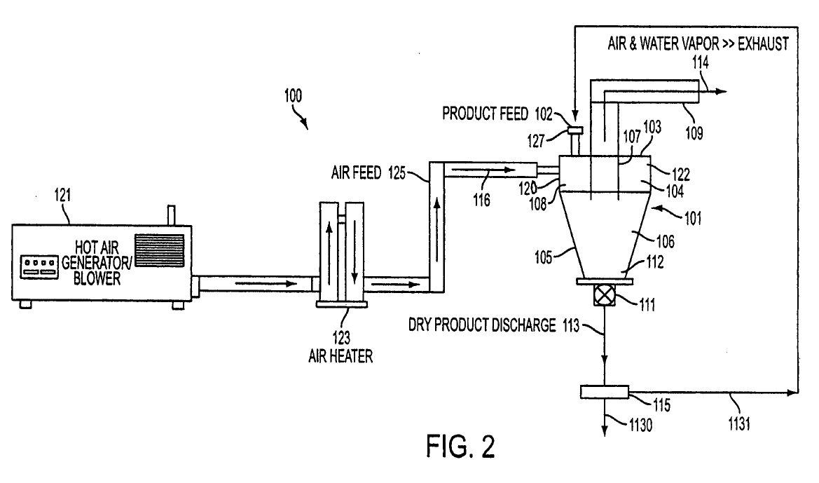

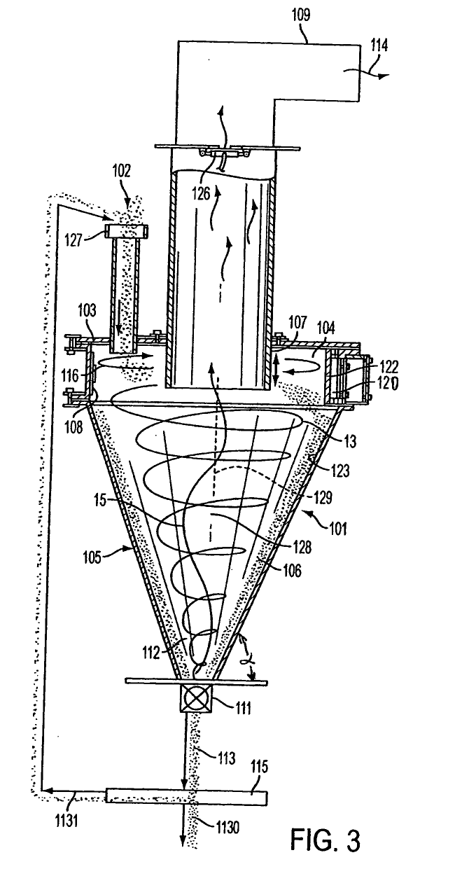

Referring now to FIGS. 2 and 3, details of an exemplary equipment arrangement and process of operating it for conducting the grinding of the low-moisture processed food in step 2 of FIG. 1 is discussed hereinafter. The low-moisture processed food that is introduced into the cyclonic system for treatment in the process of this invention may be derived from commercial food manufacture or other sources of low-moisture processed food materials. The low-moisture processed food may be in the form of discrete whole pieces as originally manufactured, or as portions, parts, fragments, shreds, fragments, and so forth thereof.

Referring to FIG. 2, an exemplary system 100 for performing grinding of low-moisture processed food according to a process embodiment of this invention is shown. Cyclone 101 is a structural enclosure comprised of two fluidly communicating sections: an upper cylindrical enclosure 103 defining a chamber 104; and a lower truncated conical shaped enclosure 105 that defines a cavity 106. Both the upper and lower enclosures are annular structures in which a solid wall or shell encloses an interior space. In this illustration, the upper enclosure 103 has a generally uniform cross-sectional diameter, while the lower enclosure 105 tapers inward towards its lower end 112. In a non-limiting embodiment, the taper angle α of lower enclosure 105 may range from about 66 to about 70 degrees. For purposes herein, the terminology “enclosure” means a structure that encloses a chamber, cavity, or space from more than one side.

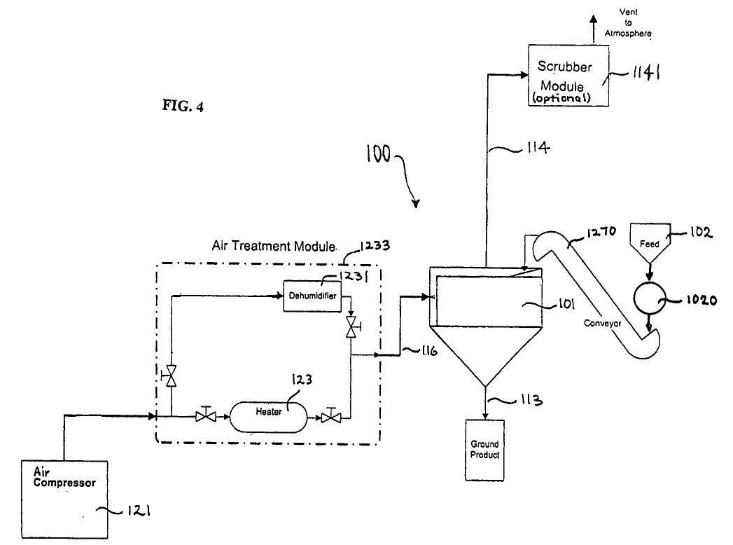

Compressed air 116 and low-moisture processed food 102 are separately introduced into the cyclone 101 at the upper enclosure 103. The processed low-moisture processed food is discharged as a solid particulate 113 from the lower end 112 of the cyclone 101. A valve mechanism 111, such as a rotary valve or rotary air-lock, is shown that permits extraction of dried, ground food product from the cyclone without interrupting continuous operation of the system and which minimizes leakage of the introduced air from the cyclone 101. If the cyclone 101 is operated without an air-lock or the like at the bottom discharge end of the cyclone 101, the system generally will run less efficiently as air will be forced out of the lower end 112, which will need to be compensated for in the air feed rate. Air, and possibly some small amount of moisture vapor released from the low-moisture food during treatment within the cyclone 101, is exhausted as exhaust gases 114 from the cyclone via sleeve 107 and exhaust duct 109. Some nominal amount of light debris may be liberated from the food during processing in the cyclone, and may be eliminated with the exhaust gas stream 114. The exhaust gas stream 114 optionally may be particle filtered, and/or scrubbed to strip out volatile compounds or other compounds, such as using a separate scrubber module, e.g. a packed bed type scrubber, before it is vented to the atmosphere (e.g., see FIG. 4, feature 1141). Sieving device 115 is described in more detail later herein. Generally, it is used to separate the oversize or coarser product 1131, i.e., the unground higher-density portion in particulate product 113 from the finer ground portion 1130 of the food product introduced into the cyclone 101.

To introduce the compressed air 116 into cyclone 101, an air pressurizing mechanism 121, such as a blower or air compressor, generates a high volume, high velocity compressed air stream that is conducted via air ducting 125 through an optionally used air heater 123, and from there is introduced into upper enclosure 103 of cyclone 101. Heating the compressed air before its introduction into the cyclone 101 is not necessarily required. However, it may be used for added moisture content control or adjustment in the product, if desired. For purposes herein, the term “compressed air” refers to air compressed to a pressure above atmospheric pressure, e.g., above 14.7 psia (lb./inch² absolute). The term “heated air” refers to air heated to a temperature above ambient temperature, e.g., above 75° F. (24° C.). The term “compressed heat air” refers to air having both these characteristics.

The compressed air 116 is introduced into chamber 104 substantially tangentially to an inner wall 108 of the upper enclosure 103. This can be done, for example, by directing the air stream 116 to a plurality of holes 120 (e.g., 2 to 8 holes) circumferentially spaced around and provided through the wall 108 of the upper enclosure 103 through which the air stream is introduced. Deflection plates 122 can be mounted on inner wall 108 of upper enclosure 103 for deflecting the incoming stream of air into a direction substantially tangential to the inner wall 108 according to an arrangement that has been described, for example, in U.S. patent application publication no. 2002/0027173 A1, which descriptions are incorporated herein by reference. The compressed air may be introduced into the upper enclosure 103 of cyclone 101 in a counter-clockwise or a clockwise direction.

The introduced air 10 generally may be further pressurized cyclonically in the chamber 104 and cavity 106. Due to the centrifugal forces present in the cyclonic environment, it is thought that the pressure nearer the outer extremities of the cavity 106 is substantially greater than atmospheric pressure, while the pressure nearer the central axis of the cavity 106 is less than atmospheric pressure. As shown in FIG. 3, as a non-limiting illustration, after being introduced into upper enclosure 103, the compressed air 116 spirals or otherwise travels generally along a large downward path as a vortex 13 through the upper enclosure 103 and the lower conical shaped enclosure 105 until it reaches a lower end 112 thereof. In this illustration, near the lower end 112 of the cavity 106 defined by the inner walls 123 of lower enclosure 105, the downward direction of the air movement is reversed, and the air (and any moisture vapor released from the food during treatment within the cyclone 101) whirls back upwardly as a smaller vortex 15 generally inside the larger vortex 13. The smaller vortex 15 flows back up from the lower end 112 of the lower enclosure 105 in a central region 128 located proximately near the central axis 129 of the cyclone 101 and generally inside the larger vortex 13. The smaller vortex 15 flows upward until exiting the enclosure via sleeve 107 and then exhaust duct 109.

A vortex breaking means (not shown) optionally can be interposed below or inside the lower end 112 to encourage the transition of the larger vortex 13 to the smaller vortex 15. Various vortex breaking arrangements for cyclones are known, such as the introduction of a box-shaped enclosure at the bottom of the conical enclosure.

The low-moisture processed food 102 is separately introduced into upper enclosure 103. The introduced low-moisture processed food drops gravitationally downward into chamber 104 until entrained in the air vortex 13 within cyclone 101. Preferably, the low-moisture processed food is introduced into upper enclosure 103 in an orientation such that it will fall into the cyclonic vortex 13 generated within cyclone 101, where located in the space between the sleeve 107, and inner wall 108 of the upper enclosure 103. This feed technique serves to minimize the amount of low-moisture processed food that may initially fall into extreme inner or outer radial portions of the vortex where the cyclonic forces that the food experiences may be lower.

The entrained food travels in the vortex 13 of air spiraling or otherwise traveling downward through the lower enclosure 105 until reaching the lower end 112 of the lower enclosure 105. During this downward flow path, the grinding effects on the food may occur at different times respective times and at different places during the downward flow path of the food through the cyclone. While not desiring to be bound to any theory, it is thought that possible pressure-gradient and coriolis forces across, cavitation explosions, and the collision interaction between the food particles entrained in the high-velocity cyclonically pressurized air may be violently disruptive to the physical structure of that material. Alternatively, or in addition thereto, the centrifugal force of the vortex may moves the food forcefully against inner walls 108 and 123 of the enclosure. These modes of attrition, individually or in combination, or other modes of attrition that may occur within the cyclone which may not be fully understood, bring about comminuting (grinding) of the food concurrent. As a result, during this movement of the food from the upper enclosure 103 down to the lower end 112 of the lower enclosure 105, the processed food is physically processed in beneficial ways. The unit 101 requires no mechanical moving parts for effecting grinding of the processed food.

In a further embodiment of the invention, the discharged solid particulate product 113 can be screened, such as using a sieve, such as a screen sieve or other suitable particulate separation/classifying mechanism 115, to sort and separate the finer fraction of ground food 1130 in the solid particulate product 113 that have particle sizes meeting a size criterion, such as being less than a predetermined size, which are suitable for post-grinding processing, from the coarser product fraction 1131. The coarser (oversize) product fraction 1131 can be redirected into the upper enclosure of the cyclone for additional processing therein. A conveyor (not shown) could be used to mechanically transport the coarser material back to feed introducing means 127 or other introduction means in upper enclosure 103 of cyclone 101. Also, feed introducing means 127 may be an inclined conveyor (e.g., see FIG. 4, feature 1270), which transports dual density feed material from a lower location up to and into chamber 104 of the cyclone 101 at the upper enclosure 103.

It will be appreciated that sleeve 107 can be controllably moved up and down to different vertical positions within cyclone 101. In general, the lower sleeve 107 is spaced relative to the cavity 106, the smaller the combined total volume of the cyclone 101 which is available for air circulation. Since the volume of air being introduced remains constant, this reduction in volume causes a faster flow of air, causing greater cyclonic effect throughout cavity 106 and consequently causing the introduced food to be ground to circulate longer in the chamber 104 and the cavity 106. Raising the sleeve 107 generally has the opposite effect. For a given feed and operating conditions, the vertical position of sleeve 107 can be adjusted to improve process efficiency and yield.

Also, a damper 126 can be provided on exhaust duct 109 to control the volume of air permitted to escape from the central, low-pressure region of cavity 106 into the ambient atmosphere, which can affect the cyclonic velocities and force gradients within cyclone 101. Other than the optional damper, the unit 101 generally requires no moving parts for operation, and particularly with respect to effecting the grinding action which occurs within the unit.

By continually feeding processed food into cyclone 101, a continuous throughput of ground food product material 113 is obtained. A non-limiting example of a commercial apparatus that can be operated in a continuous manner while processing food according to processes of this invention is a WINDHEXE apparatus, manufactured by Vortex Dehydration Systems, LLC, Hanover Md., U.S.A. Descriptions of that type of apparatus are set forth in U.S. patent application publication no. 2002/0027173 A1, which descriptions are incorporated in their entirety herein by reference.

The cyclonic system 100 can provide very high heat transfer rates from hot air to processed food for any further drying or moisture control that may be optionally desired, and mechanical energy to crack and granulate food as it descends through the conical section of the dryer. The food exiting the cyclone 101 exhibits a flowable solid particulate type form, which may be a flour or powder like material.

The processing unit 101 may be left relatively clean and tidy, as low-moisture processed material does not tend to cling as residue to the interior walls of the process unit used to grind the food into granular form. This can facilitate any desired change-over for processing a different type of feed material within the same unit.

In one process scheme for processing low-moisture processed food, the introduction of the compressed air into the cyclone comprises supplying compressed air at an inlet pressure within the range of from about 10 psig (lb./inch² gauge) to about 100 psig, particularly from about 30 psig to about 60 psig, and more particularly from about 25 psig to about 35 psig.

As noted, heating of the compressed air before its introduction into the processing unit is not ordinarily required for processing the low-moisture processed food according to embodiments herein. If heated compressed air is used, heated air may be introduced into the cyclone at an appropriate temperature for the food and purpose intended. Generally, the temperature of the compressed air introduced into the cyclonic processing chamber will be from about 0° F. to about 500° F., particularly about 32° F. to about 120° F., and more particularly about 40° F. to about 100° F. As the feed material is low-moisture content, the need for heated air is reduced or eliminated in most instances.

The volumetric introduction rate of the compressed air into the cyclone is within the range of from about 500 cubic feet per minute (CFM) to about 10,000 CFM, particularly from about 800 CFM to about 10,000 CFM, and more particularly from about 1,000 CFM to about 3,000 CFM.

The feed rate of the low-moisture processed food can vary, but generally may be in the range of about 1 to about 300 pounds per minute, particularly about 50 to about 150 lbs./min, for about a 1 to about a 10 foot diameter (maximum) cyclone. The cyclone diameter may be, for example, about 1 to about 10 feet in diameter, particularly about 1 to about 6 feet in diameter.

The low-moisture processed food may be processed within the above-noted cyclone arrangement within a very short period of time. In one embodiment, upon introducing the low-moisture processed food into the cyclone, a granulated product thereof is discharged from the processing unit within about 15 seconds, and particularly within about 1 to about 5 seconds.

Substantially all the introduced low-moisture processed food may be discharged as processed product within such a short period of time. The above-noted processing temperatures and durations applied during grinding of the low-moisture processed food generally are low enough to help prevent any significant undesired changes in the starch structure, or other physico-chemical attributes relevant to food-processing, from occurring during the grinding treatment such as described herein. Any starch content present in the low-moisture food (before granulation) is preserved substantially intact through the grinding treatment performed in accordance with this invention on the low-moisture processed food. Conventional milling generally employs moving parts to effect attrition of a material, which tends to generate localized heat. Intense or unduly elevated heat may increase the risk of degradation of desirable food functional features.

In one embodiment, the low-moisture processed food used as the feed material of a grinding process generally contains less than 14 wt. % moisture, and particularly less than 12 wt. % moisture, and generally ranges from 1 wt % to 14 wt % moisture, and particularly from 6 wt % to 12 wt %, when introduced into the cyclone 101 of system 100. Feed material at higher moisture levels may also be used to the extent it does not agglomerate or build-up into a sticky or pasty mass inside the cyclone or otherwise become non-processable. The compressed air fed into the cyclone ordinarily is unheated, although that condition may be used. In one embodiment, the food material is processed at ambient (nonheated) temperature, such as at a temperature of about 65 to about 80° F. (about 18 to about 27° C.). It may be necessary to dehumidify the compressed air before it is introduced into the cyclone unit in high relative humidity (RH) conditions (e.g. RH greater than about 50%) to ensure that the feed material can be attrited into granular form and does not build-up into a sticky or pasty mass inside the cyclone. The air may be dehumidified using a conventional cooling coil unit or similar device used for dehumidification of process air (e.g., see FIG. 4, feature 1231). The dehumidifer or air dryer 1231 may be a commercial unit for the general purpose, e.g., a Model MDX 1000 air dryer from Motivair, Amherst, N.J.

Under certain conditions, the compressed air fed into the cyclone may be heated in an air heater 123 to induce some further dehydration of the low-moisture feed material while it is being ground in the same process unit (see FIG. 4). The dehumidifer 1231 and heater 123 are units of the subsystem represented as the air treatment module 1233 in FIG. 4. As indicated in FIG. 4, control valves and the like may be used to selectively control and manage air flow through the various air treatment units in module 1233. The ground (granulated) food product obtained from the process also generally may contain about 1 wt. % to about 14 wt % moisture, or otherwise the same or lower level of moisture as the feed material to the extent no additional moisture is introduced during processing in the cyclone.

Ground food product obtained by a grinding process preferably has commercially useful particle sizes. In one embodiment, the dried, ground food product obtained by processing low-moisture processed food according to an embodiment of this invention generally may have an average particle size of about 1 micron to about 1,000 microns, particularly about 2 to about 1,000 microns. In one embodiment, the solid particulate product obtained as the bottoms of the cyclone comprise at least about 50% ground food product having an average particle size of about 1 micron to about 1,000 microns.

The granular food product obtained in accordance with embodiments of this invention is edible and may be used in a wide variety of foodstuffs for a variety of purposes. The granulated food product preferably does not have an unpleasant taste or odor, and may be easily processed with doughs, processed meats, and other processed foods without loss of quality. For example, the granulated food product of embodiments of this invention serves as an economical replacement for original ingredients used in such food products. The granulated food product has ability to contribute flavor and function without adversely impacting such food products. The granulated food product obtained generally is shelf stable, and may be used to impart flavor and/or functional properties to a food product being manufactured after many months of storage of the granulated food product, such as up to about twelve months storage/shelf life or more.

In some preferred embodiments, the low-moisture foods processed according to an embodiment of this invention comprise low-moisture processed foods containing a grain-based ingredient. The grain-based ingredient may include one or more principal parts of cereal grain, such as the pericarp or bran (external layer of grain), the endosperm (farinaceous albumen containing starch), or the germ (seed embryo). Examples are cereal grains, meals, flours, starches, or glutens, obtained from grinding cereal grains, such as wheat, corn, oats, barley, rice, rye, sorghum, milo, rape seed, legumes, soy beans, peanuts, beans, and mixtures thereof, as well as various milling products of such cereal grains, such as bran. In one embodiment, the low-moisture processed food generally may contain, on a dry basis, about 1 to about 99 wt. %, and particularly about 5 to about 95 wt % grain-based ingredient, and the remainder may be comprised of one or more of meat(s), non-grain based agricultural food materials, and/or food additives.

In one embodiment, the grain-based ingredient comprises a farinaceous material, and particularly a farinaceous material obtained or derived from cereal grain(s). Farinaceous materials include the above-noted cereal grains, meals or flours, as well as tuberous foodstuffs, such as tapioca, dried potatoes, and flours thereof, and also dried onions, dried garlic, or the like. These starch-containing materials can be processed according to this invention without incurring undue gelatinization or other undesirable changes. That is, starch content of the processed food is retained substantially intact through granulation processing according to embodiments herein from a structural and functional standpoint. The grinding unit such described herein permits relatively short duration, low temperature processing to be used to yield a granular product, which is thought to help inhibit and avoid starch transformations (e.g., gelatinization) in starch content of low-moisture processed food during processing.

The low-moisture processed foods containing a grain-based ingredient may be selected, for example, from low-moisture dough-based materials. In one embodiment, these low-moisture dough-based materials are derived from substantially or fully cooked processed food products and/or physical pieces thereof. Such low-moisture dough-based materials may be, for example, cereals, pet foods, crackers, baked goods, breads, snack chips, and so forth. The low-moisture materials thereof may be collected as part of food manufacture processing performed on finished food products.

In one embodiment, for example, low-moisture sheetable dough-based materials collected from a processed food production line may be ground in a grinding procedure in accordance with an embodiment of this invention to yield a re-usable food grade granular product. For example, the granular product substantially retains any starch structure remaining after any cooking of the processed food, such that it is still suitable for a fresh dough making. It may provide at least in part a stable functional substitute for fresh dough ingredients such as flour. “Sheetable dough” is a dough capable of being placed on a generally smooth surface and rolled to a desired final thickness without tearing or forming holes. Low-moisture sheetable doughs used in dough-based food products include, for example, low-moisture cracker doughs, low-moisture cookie doughs (e.g., base cake), low-moisture snack chip doughs, low-moisture pizza crust doughs, and the like.

The crackers generally may include ingredients commonly used in commercial manufacture of such products. These dough recipes may comprise bread flour, water, yeast, salt, and oil or shortening, and optional other ingredients such as gluten, alpha amylase enzyme, dough relaxers, mold inhibitors, eggs ingredients, sweeteners, flavoring agents and so forth, in useful proportions. The pizza dough recipe may include those described in expired U.S. Pat. No. 4,303,677, and commonly assigned published U.S. Pat. Appln. No. US 2002/0197360 A1, which descriptions are incorporated herein by reference.

The granulated product obtained from low-moisture dough-based materials in this manner may be used as a replacement for fresh dough ingredients in a food production line at substantially unrestricted levels. The granulated product obtained from low-moisture dough may be used at levels of 0.1 wt % or more, and more particularly about 1 to about 99 wt %, in place of fresh flour in a dough batch.

In another embodiment, low-moisture breakfast cereal production materials containing a grain-based ingredient may be ground in a procedure yielding a stable granular material that can be re-used in cereal product production. One source of low-moisture breakfast cereal production materials includes non-particulated extruded rope materials comprising the cereal-making ingredients. Breakfast cereal products include those made as grain-based extruded products. These products generally are manufactured by feeding an at least partly ungelatinized, moistened grain-based material and other cereal ingredients to an extruder having at least one rotating screw. The grain-based material is worked by rotating the screw to impart mechanical energy to mix the grain-based material and other ingredients of the breakfast cereal to form a plasticized doughy mass which is forced through at least one die orifice in a die plate to obtain an extrudate rope. Individual pieces of cereal are then formed from the extrudate rope, such as by intermittent severing of the rope using a reciprocating die. The pieces of cereal are then dried to provide a generally flowable mass of low moisture cereal particles, prior to packaging.

The grain-based feed material that may be used for cereal making includes those already noted, which may comprise wheat, corn, barley, oats, rice, rye, sorghum, and mixtures thereof. If desired, the feed material may include supplemental materials to improve flavor, texture, appearance, nutrition, or other properties of the finished cereal product, including materials commonly used for these various purposes in cereals. Such supplemental materials may include, for example, one or more of sweeteners (e.g., sugars, syrups, honey), salt, minerals (e.g., calcium), vitamins (e.g., folates), flavorings (chocolate, vanilla, cinnamon, fruit flavor), fiber source (e.g., cellulose, pectin, psyllium), in suitable amounts.

Examples of types of low-moisture cereal products that may be reformed in accordance with this invention, include, for example, Post® Alpha-Bits®, Post® Honeycomb®, Post® Fruity Pebbles®, Post® Bran flakes, and Post® Shredded Wheat cereals, and the like.

In yet another embodiment, low-moisture pet food materials containing a grain-based ingredient may be ground in a procedure yielding a stable granular material that can be re-used in pet food production. Dog and cat foods, for example, are generally prepared as either meal-type or canned-type rations. Such foods are generally formulated from a combination of proteinaceous and farinaceous materials. The proteinaceous material is derived from meat and/or meat sources, and/or vegetable protein sources. The farinaceous material is derived from grain products and contains starch generally but not necessarily for all cases as a major component. Low-moisture foods of these types of pet food production may be collected for re-use according to this invention.

The low-moisture pet food production from which granular products also may be obtained and re-used includes so-called chewy dog snacks, such as those containing cereal-starch materials as textural agents or for other purposes. Examples of such chewy dog snacks include Nabisco® Milk-Bone® brand pet snacks. They also include pet snacks such as those described in U.S. Pat. No. 4,997,671 (Nabisco), which descriptions are incorporated herein by reference.

Low-moisture pet food production having a moisture content of generally less than 14 wt. %, and particularly less than 12 wt. %, may be reformed into a granular product suitable for use in pet food production using the grinding process of the present invention. Low-moisture dog food according to an embodiment of this invention may have particles size ranging from about 2 to about 50 microns.

The Examples that follow are intended to illustrate, and not limit, the invention. All percentages are by weight, unless indicated otherwise.

### EXAMPLES

### Example 1

Nabisco® Premium Saltine® crackers, obtained in their packaged condition (e.g., <14 % moisture), were fed into a WINDHEXE apparatus for circular vortex air-flow material grinding. The WINDHEXE apparatus was manufactured by Vortex Dehydration Systems, LLC, Hanover, Md., U.S.A. The basic configuration of that type of apparatus is described in U.S. patent application publication no. 2002/0027173 A1, and reference is made thereto. The process unit had four inlet ports equidistantly spaced around the upper portion of the apparatus through which the compressed air stream was concurrently introduced in a counter-clockwise direction.

A three-foot diameter WINDHEXE apparatus was tested. The diameter size refers to the chamber size of the enclosure into which air and low-moisture processed food introductions were made. The conditions of this experiment are described below. The feed rate of the low-moisture crackers was set for an approximate discharge of 3 pounds solid product per minute, and approximately 20 pounds of food material was tested in the apparatus. The low-moisture processed food was loaded into a hopper that directly fed onto a three-inch belt conveyor that fed into the WINDHEXE apparatus. Testing was performed in the three-foot diameter WINDHEXE apparatus with compressed air introduced at 75-80° F., an air introduction rate of 1,000 cubic feet per minute (cfm) and pressure of 40-50 psig.

A food product exiting the apparatus was in finely ground form. This granulated food product was discharged from the bottom of the cyclone in about two seconds after the low-moisture processed food had been introduced into the processing unit. The dry granulated food product obtained had an average particle size of about 5 to about 50 microns. It was shelf stable, well-retained flavor through the grinding treatment, and it was functionally suitable for re-use as a cracker ingredient in a similar cracker product line from which it was originally used. It will be appreciated that it may be useful in different food product lines. Additional studies have shown that feed rate and air temperature variation may be used to control the low-moisture product granulation and moisture content.

### Example 2

The ground Nabisco Premium Saltine® soda cracker product obtained using the processing described in Example 1 was studied to evaluate its capability of being reformed and reused in cracker dough.

A batch of crackers was prepared containing the ground crackers (i.e., “meal rework”) recovered from the above-described vortex processing used in Example 1 as re-work in a separate cracker production run. A cracker dough was prepared in a conventional manner in a dough forming stage with the following general formulation:

| Dough Ingredient | Percent (wt.) |
|---|---|
| Flour | 55 |
| rework meal | 4 |
| granulated sugar | 6 |
| wheat germ | 7 |
| corn starch | 3 |
| soy oil | 2 |
| corn syrup | 2 |
| malt syrup | 2 |
| water | 18 |
| Dough conditioners & | <2 |
| other minor ingredients | |

The dough held together and was sheetable. It was rotary wire cut into thin squares (21.5 g/10 pieces). The crackers were baked for several minutes in an oven having a baking chamber temperature of about 350° F. The product crackers prepared with the meal rework were crisp and had a pleasant taste.

In separate studies performed using similar equipment and processing conditions, other low-moisture dough-based materials were separately examined including samples of Nabisco® Wheat Thins®, and Nabisco® Oreo Base Cake®. The resulting granulated products of each run were discharged from the bottom of the cyclone in about two seconds after the respective low-moisture dough-based materials had been introduced into the processing unit. They also were shelf stable powders and were functionally suitable for re-use as a batch ingredient in the same or different dough-based production line.

### Example 3

In a separate trial, Nabisco® Premium Saltine® crackers, obtained in their packaged condition (e.g., <14% moisture), were fed into a WINDHEXE apparatus of a slightly different configuration for circular vortex air-flow material grinding. The WINDHEXE apparatus used in this trial was four-foot in diameter, and the basic structural configuration otherwise was similar to that described in Example 1, albeit at a different scale. The process conditions used for this trial were as follows. The feed rate of the low-moisture crackers was set for an approximate discharge of 3 pounds solid product per minute, and approximately 20 pounds of food material was tested in the apparatus. The low-moisture processed food was loaded into a hopper that directly fed onto a three-inch belt conveyor that fed into the WINDHEXE apparatus. Testing was performed in the four-foot diameter WINDHEXE apparatus with compressed air introduced at 75-80° F., an air introduction rate of 2,500 cubic feet per minute (cfm), and pressure of 40-50 psig.

A food product exiting the apparatus was in finely ground form. This granulated food product was discharged from the bottom of the cyclone in about two seconds after the low-moisture processed food had been introduced into the processing unit. The dry granulated food product obtained had an average particle size of about 5 to about 50 microns.

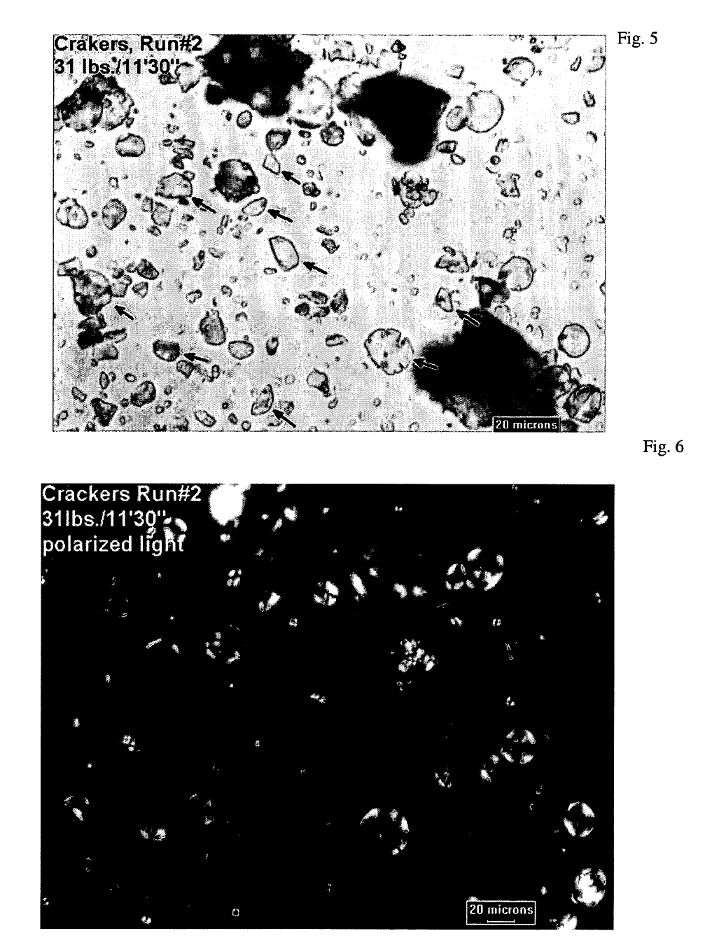

The dried and granulated cracker product obtained was evaluated via microscopy (300× magnification) under normal and polarized light conditions (See FIGS. 5 and 6). Referring to FIG. 6, in which the sample was viewed under polarize light, numerous starch molecules are seen with a crossing pattern on their surface, which is attributable to birefringence effects and is understood to indicate that the granules are not gelatinized. Therefore, the granules obtained from the cracker processed in the manner described above appear to be essentially intact.

### Example 4

Low-moisture pieces and fragments of Post® Honeycomb® cereal (7 wt. % moisture) were collected from a cereal production run operated on a Buhler single screw extruder, followed by sizing, in which the recovered fraction was −1 inch/+0.25 inch.

After sizing and drying, the low-moisture cereal material was fed into a WINDHEXE apparatus for circular vortex air-flow material grinding, which was manufactured by Vortex Dehydration Systems, LLC, Hanover, Md., U.S.A., and had the basic configuration as previously indicated herein The process unit had four inlet ports equidistantly spaced around the upper portion of the apparatus through which the compressed air stream was concurrently introduced in a counter-clockwise direction.

A three-foot diameter WINDHEXE apparatus was tested. The diameter size refers to the chamber size of the enclosure into which air and low-moisture processed food introductions were made. The conditions of this experiment are described below. The feed rate of the low-moisture cereal was set for an approximate discharge of 3 pounds solid product per minute, and approximately 200 pounds of food material was tested in the apparatus. The low-moisture processed food was loaded into a hopper that directly fed onto a three-inch belt conveyor that fed into the WINDHEXE apparatus. Testing was performed in the three-foot diameter WINDHEXE apparatus with compressed air introduced at 75-80° F., an air introduction rate of 1,000 cubic feet per minute (cfm) and pressure of 40-50 psig.

A cereal product exiting the apparatus was in finely ground form. This granulated cereal product was discharged from the bottom of the cyclone in about two seconds after the low-moisture processed food had been introduced into the processing unit. The granulated cereal product obtained had a particle size of −20 mesh screen size and a moisture content of about 2%. It was shelf stable, well-retained flavor through the grinding treatment, and it was functionally suitable for re-use as a cereal batch ingredient in a similar cereal production line to which it was originally used. It will be appreciated that it may useful in different cereal product lines.

Additional studies have shown that feed rate and air temperature variation may be used to control the low-moisture cereal product granulation and moisture content.

In separate studies performed using similar equipment and processing conditions, other low-moisture cereal materials were separately examined which included low-moisture samples of Post® Fruity Pebbles®, Post® Bran flakes, Post® Honeycomb® Shredded Wheat, and corn grit products. The resulting granulated cereal products of each run were discharged from the bottom of the cyclone in about two seconds after the respective low-moisture cereal materials had been introduced into the processing unit. They also were shelf stable powders and were functionally suitable for re-use as a cereal batch ingredient in the same or different cereal production line.

### Example 5

Post® Alpha-Bits® cereal pieces, obtained in their packaged condition (e.g., <14% moisture content), were studied to evaluate their capability of being reformed after being granulated in a vortex apparatus as described herein.

Testing was performed in the above-mentioned three-foot diameter WINDHEXE apparatus with compressed air introduced at 75° F., 1,000 cfm and 40-50 psig. About 200 pounds of the whole Post® Alpha-Bits® cereal pieces were introduced into the cyclone described in Example 1. The process converted the low-moisture cereal pieces into a dry and powdery material having an average particle size of about 2 to about 50 microns, and the granulated material had a moisture content of less than 14 wt %. Granulated product was discharged from the bottom of the cyclone in about two seconds after the low-moisture cereal pieces had been introduced into the processing unit.

A batch of cereal pieces were prepared containing the ground cereal pieces as “meal rework” recovered from the above-described vortex processing, as re-work in additional cereal production. A cereal dough was prepared in a conventional manner in a dough forming stage with the following general formulation:

| Dough Ingredient | Percent (wt.) |
|---|---|
| oat flour | 58 |
| rework meal | 10 |
| corn flour | 9 |
| water | 23 |

The dough was mixed in Hobart mixer and extruded using a Bonnot extruder having a die providing a shaped extrudate in rope form which was cut into small individual pieces of a size comparable, after being baked, to commercial Post® Alpha-Bits® cereal pieces. The extrudate maintained a uniform shape, held together well, and flowed easily. The dough pieces were suitable for baking into dry palatable cereal pieces.

### Example 6

Cereal-dough based pet food biscuits were studied to evaluate their capability of being reformed after being granulated in a vortex apparatus as described herein. Pet food biscuits were prepared in a similar manner as described for the Control sample illustrated in U.S. Pat. No. 5,000,943, which descriptions are incorporated herein by reference, with the modification that the control dough formulation generally contained 87% flour, 7% meat and bone meal, 2% tallow, 1% salt, 0.7% dicalcium phosphate, 0.9% natural flavorants, 0.1% vitamin premix, 0.15% calcium carbonate, and 0.4% dough conditioners. About 20-30% water was added in the preparation of the dough, based on the overall dough recipe. The dough was sheeted, fed to a rotary molder having a die, the extrudate was cut into biscuit shapes, which then were baked at about 300-475° F. for about 8-25 minutes. The dried biscuits had shapes similar to comrnercial MilkBone® products. The moisture content of the dried biscuits was less than 14% by weight.

Testing was performed in the above-mentioned three-foot diameter WINDHEXE apparatus with compressed air introduced at 180° F., 1,000 cfm and 48 psig. About 200 pounds of the pet food biscuits were introduced into the cyclone described in Example 1. The process converted the low-moisture pet food biscuits into a dry and powdery material having an average particle size of about 2 to about 50 microns, and a moisture content of about 7%. Granulated product was discharged from the bottom of the cyclone in about two seconds after the low-moisture pet food biscuits had been introduced into the processing unit.

A batch of pet food biscuits were prepared containing the ground pet food biscuits as “meal rework” recovered from the above-described vortex processing, as re-work in additional pet food biscuit production. A pet food dough was formulated and prepared into pet food biscuits in a manner similar to that described above with the modification that the pet food dough formulation contained about 7% meal rework.

The dough containing the meal rework had the following general formulation:

| Dough Ingredient | Percent (wt.) |
|---|---|
| Flour | 80 |
| rework meal | 7 |
| Meat and Bone Meal | 7 |
| tallow | 2 |
| salt | 1 |
| Diacalcium phosphate | 0.6 |
| Natural flavorants | 0.9 |
| Vitamin premix | 0.14 |
| Calcium carbonate | 0.14 |
| Dough conditioners | 0.4 |

The dough was formed into individual dough pieces, baked in an oven and dried in a similar manner as described above for the pet food dough that omitted meal rework. The pet food biscuits made with meal rework was found to be satisfactory for dough- and pet-food biscuit-making from a processing standpoint. The granulated pet food did not substantially lose flavor or functionality during the grinding treatment, and was suitable as an edible ingredient for preparation of a pet food product. The product biscuits containing the rework were observed to be comparably palatable to dogs as dog biscuits prepared similarly except without inclusion of the meal rework.

While the invention has been particularly described with specific reference to particular process and product embodiments, it will be appreciated that various alterations, modifications and adaptations may be based on the present disclosure, and are intended to be within the spirit and scope of the present invention as defined by the following claims.

What is claimed is:

1. A granulation process for low-moisture processed food, comprising:
introducing compressed air into an enclosure that includes a truncated conical shaped section, wherein the introduced air travels along a downward path through the enclosure, including the conical section, to a lower end thereof, and the air reaching the lower end flows back up and exits the enclosure via an exhaust outlet;
introducing into the enclosure low-moisture processed food which is entrained in the introduced air traveling downward through the enclosure, wherein at least a portion of the low-moisture processed food is ground before reaching the lower end of the enclosure;
discharging a granular product including ground food product from the lower end of the enclosure, wherein the ground food product incurs sufficiently limited molecular structural degradation during the process such that the product is functionally and organoleptically acceptable to be used as rework.

2. The process of claim 1, wherein the low-moisture processed food contains less than 14 wt. % moisture as introduced into the enclosure.

3. The process of claim 1, wherein the granular product has an average particle size of about 1 micron to about 1,000 microns.

4. The process of claim 1, wherein the granular product comprises at least about 50% ground food product having an average particle size of about 1 micron to about 1,000 mm.

5. The process of claim 1, wherein the low-moisture processed food comprises a grain-based ingredient.

6. The process of claim 5, wherein the low-moisture processed food comprises, on a dry basis, about 1 to about 99 wt. % grain-based ingredient.

7. The process of claim 5, wherein the low-moisture processed food comprises farinaceous material.

8. The process of claim 1, wherein the low-moisture processed food comprises low-moisture dough-based material.

9. The process of claim 8, wherein the low-moisture dough-based material is selected from the group consisting of cereals, pet foods, crackers, cookie bases, breads, pizza crusts, and a mixture thereof.

10. The process of claim 8, wherein the low-moisture dough-based material is selected from the group consisting of low-moisture crackers, low moisture cookies, and mixtures thereof.

11. The process of claim 8, wherein the low-moisture dough-based material comprises low-moisture cereal.

12. The process of claim 8, wherein the low-moisture dough-based material comprises low-moisture pet food.

13. The process of claim 1, wherein the introducing of the compressed air comprises supplying compressed air at a pressure within the range of from about 10 psig to about 100 psig.

14. The process of claim 1, wherein the introducing of the compressed air comprises supplying compressed air at a pressure within the range of from about 25 psig to about 50 psig.

15. The process of claim 1, wherein the introducing of the compressed air comprises supplying the compressed air at a temperature within the range of about 0° F. to about 500° F.

16. The process of claim 1, wherein the introducing of the compressed air comprises supplying the compressed air at a rate of within the range of from about 500 cubic feet per minute to about 10,000 cubic feet per minute.

17. The process of claim 1, wherein the introducing of the compressed air comprises supplying the compressed air at a rate within the range of from about 1,000 cubic feet per minute to about 3,000 cubic feet per minute.

18. The process of claim 1, wherein the lower end of the enclosure communicates with a rotary valve permitting discharged of solid particulate product from the enclosure in a substantially air-tight manner.

19. The process of claim 1, wherein the introducing of the compressed air into the upper cylindrical enclosure occurs in a direction oriented generally tangentially to inner walls of the cylindrical enclosure.

20. The process of claim 1, wherein the upper cylindrical enclosure has a substantially constant diameter of about 1 to about 10 feet, and the lower enclosure comprises a truncated conical shape having a maximum diameter size where the lower enclosure adjoins the cylindrical enclosure and the maximum diameter of the lower enclosure is substantially the same as the diameter of the cylindrical enclosure.

21. A process for reworking low-moisture processed food in processed food manufacture, comprising:
introducing compressed air into an enclosure that includes a truncated conical shaped section, wherein the introduced air travels along a downward path through the enclosure, including the conical section, to a lower end thereof, and the air reaching the lower end flows back up and exits the enclosure via an exhaust outlet;
introducing into the enclosure low-moisture processed food which is entrained in the air traveling downward through the enclosure, wherein at least a portion of the low-moisture processed food is ground before reaching the lower end of the enclosure;
discharging a granular product including ground food product from the lower end of the enclosure, wherein the ground food product incurs sufficiently limited molecular structural degradation during the process such that the product is functionally and organoleptically acceptable to be used as rework;
combining at least a portion of the granular product and at least one different processed food ingredient; and
preparing a processed food product therewith.

22. A granular food product prepared from low-moisture processed food in a method comprising introducing compressed air into an enclosure that includes a truncated conical shaped section, wherein the air travels along a downward path through the enclosure, including the conical section, to a lower end thereof, and the air reaching the lower end flows back up and exits the enclosure via an exhaust outlet; introducing into the enclosure low-moisture processed food which is entrained in the air traveling downward through the enclosure, wherein at least a portion of the low-moisture processed food is ground before reaching the lower end of the enclosure; and discharging from the lower end of the enclosure a granulated product including ground food product, wherein the ground food product incurs sufficiently limited molecular structural degradation during the method such that the product is functionally and organoleptically acceptable to be used as rework.

23. The granular food product of claim 22, wherein the low-moisture processed food comprises a grain-based ingredient.

24. The granular food product of claim 23, wherein the low-moisture processed food comprises farinaceous material.

25. The granular food product of claim 22, wherein the low-moisture processed food comprises low-moisture dough-based material.
